(19) United States
(12) Patent Application Publication
(10) Pub. No.: US 2007/0002722 A1
(43) Pub. Date: Jan. 4, 2007

(54) Device, system and method of crosstalk cancellation

(76) Inventors: Georgios Palaskas, Portland, OR (US); Ashoke Ravi, Hillsboro, OR (US); Brent Carlton, Hillsboro, OR (US); Richard Nicholls, Banks, OR (US); Stanley Ling, Rocklin, CA (US); Krishnamurthy Soumyanath, Portland, OR (US); Nati Dinur, Omer (IL)

Correspondence Address: PEARL COHEN ZEDEK LATZER, LLP, 1500 BROADWAY, 12TH FLOOR, NEW YORK, NY, 10036, US

(21) Appl. No.: 11/170,790

(22) Filed: Jun. 30, 2005

(51) Int. Cl. H04J 3/10; H04J 3/22

(52) U.S. Cl. 370/201; 370/465; 370/535

(57) ABSTRACT

Briefly, some embodiments of the invention provide devices, systems and methods of crosstalk cancellation. For example, an apparatus may include a first transmission path to carry a first signal with information to be transmitted; a second transmission path to carry a second signal with information to be transmitted; a scaler associated with said first transmission path to scale said first signal into a scaled first signal; and a combiner to combine said scaled first signal and said second signal into a combined second signal on said second transmission path.

### BACKGROUND OF THE INVENTION

Some wireless communication devices may include a Multiple Input Multiple Output (MIMO) configuration, for example, to improve data transfer rate and/or communication range.

Unfortunately, crosstalk may occur among multiple transceivers of a MIMO configuration, resulting in non-optimal performance, reduced efficiency, and distorted signals, e.g., particularly when multiple transmit antennas transmit multiple, different bit-streams.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is schematic block diagram illustration of a wireless communication system able to reduce or cancel crosstalk in accordance with an embodiment of the invention;

FIG. 2 is a schematic illustration of a multi-transmitter crosstalk canceller in accordance with an embodiment of the invention;

FIG. 3 is a schematic illustration of a multi-transmitter crosstalk canceller in accordance with another embodiment of the invention;

FIG. 4 is a schematic illustration of a calibrator for calibrating a multi-transmitter crosstalk canceller in accordance with an embodiment of the invention;

FIG. 5 is a schematic illustration of a multi-receiver crosstalk canceller in accordance with an embodiment of the invention;

FIG. 6 is a schematic illustration of a multi-transmitter crosstalk canceller in accordance with yet another embodiment of the invention; and

FIG. 7 is a schematic flow-chart of a method of crosstalk cancellation in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

Embodiments of the invention may be used in a variety of applications. Some embodiments of the invention may be used in conjunction with many apparatuses and systems, for example, a transmitter, a receiver, a transceiver, a transmitter-receiver, a wireless communication station, a wireless communication device, a wireless Access Point (AP), a modem, a wireless modem, a personal computer, a desktop computer, a mobile computer, a laptop computer, a notebook computer, a Personal Digital Assistant (PDA) device, a tablet computer, a server computer, a network, a wireless network, a Local Area Network (LAN), a Wireless LAN (WLAN), devices and/or networks operating in accordance with existing IEEE 802.11, 802.11a, 802.11b, 802.11e, 802.11g, 802.11h, 802.11i, 802.11n, 802.16 standards and/or future versions of the above standards, a Bluetooth device or network, a ZigBee device or network, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, a Multiple Input Multiple Output (MIMO) transceiver or device, a Single Input Multiple Output (SIMO) transceiver or device, a Multiple Input Single Output (MISO) transceiver or device, a Multi Receiver Chain (MRC) transceiver or device, a transceiver or device having “smart antenna” technology or multiple antenna technology, or the like. It is noted that embodiments of the invention may be used in various other apparatuses, devices, systems and/or networks.

The term “crosstalk” as used herein may include, for example, interference, disturbance, parasitic noise, ElectroMagnetic Interference (EMI), or the like.

Although portions of the discussion herein may relate, for demonstrative purposes, to crosstalk cancellation, embodiments of the invention are not limited in this regard, and may include, for example, crosstalk reduction, crosstalk elimination, crosstalk handling, avoidance of possible or potential crosstalk, or the like.

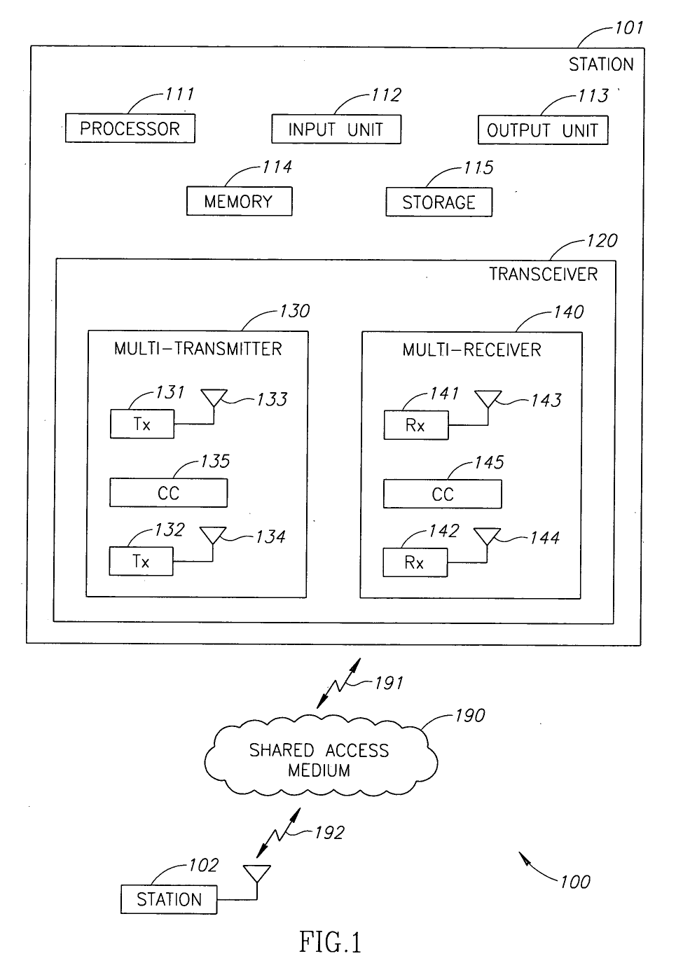

FIG. 1 schematically illustrates a block diagram of a wireless communication system 100 able to reduce or cancel crosstalk in accordance with an embodiment of the invention. System 100 may include one or more wireless communication stations, e.g., stations 101 and 102. System 100 may optionally include one or more base stations, servicing stations and/or access points. Station 101 and station 102 may communicate using a shared access medium 190, for example, through wireless communication links 191 and 192, respectively.

Station 101 may include, for example, a processor 111, an input unit 112, an output unit 113, a memory unit 114, a storage unit 115, and a transceiver 120. Station 101 may further include other hardware components and/or software components.

Processor 111 may include, for example, a Central Processing Unit (CPU), a Digital Signal Processor (DSP), a microprocessor, a controller, a chip, a microchip, an Integrated Circuit (IC), or any other suitable multi-purpose or specific processor or controller.

Input unit 112 may include, for example, a keyboard, a keypad, a mouse, a touch-pad, or other suitable pointing device or input device. Output unit 113 may include, for example, a Cathode Ray Tube (CRT) monitor or display unit, a Liquid Crystal Display (LCD) monitor or display unit, or other suitable monitor or display unit.

Memory unit 114 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units.

Storage unit 115 may include, for example, a hard disk drive, a floppy disk drive, a Compact Disk (CD) drive, a CD-ROM drive, or other suitable removable or non-removable storage units.

Transceiver 120 may include, for example, a wireless multi-transmitter 130 and a wireless multi-receiver 140.

Multi-transmitter 130 may include, for example, one or more Radio Frequency (RF) transmitters or transmitter chains, or a multi-transmitter configuration able to transmit signals, blocks, frames, transmission streams, packets, messages and/or data, e.g., through one or more antennas. For example, in one embodiment, multi-transmitter 130 may include two transmitters 131 and 132, connected to two transmit antennas 133 and 134, respectively. In one embodiment, transmitters 131 and 132 may be able to operate in accordance with the same wireless communication standard or protocol, for example, IEEE 802.11, 802.11a, 802.11b, 802.11e, 802.11g, 802.11h, 802.11i, 802.11n, 802.16 standards, Bluetooth, Zigbee, or the like. In another embodiment, transmitter 131 may be able to operate in accordance with a first wireless communication standard or protocol, and transmitter 132 may be able to operate in accordance with a second, different, wireless communication standard or protocol.

Multi-receiver 140 may include, for example, one or more RF receivers or receiver chains, or a multi-receiver configuration able to receive signals, blocks, frames, transmission streams, packets, messages and/or data, e.g., through one or more antennas. For example, in one embodiment, multi-receiver 140 may include two receivers 141 and 142, connected to two receive antennas 143 and 144, respectively. In one embodiment, receivers 141 and 142 may be able to operate in accordance with the same wireless communication standard or protocol, for example, IEEE 802.11, 802.11a, 802.11b, 802.11e, 802.11g, 802.11h, 802.11i, 802.11n, 802.16 standards, Bluetooth, Zigbee, or the like. In another embodiment, receiver 141 may be able to operate in accordance with a first wireless communication standard or protocol, and receiver 142 may be able to operate in accordance with a second, different, wireless communication standard or protocol.

Antenna 133, antenna 134, antenna 143 and/or antenna 144 may include an internal and/or external RF antenna, for example, a dipole antenna, a monopole antenna, an omni-directional antenna, a transmit antenna, a receive antenna, a transmit/receive antenna, an end fed antenna, a circularly polarized antenna, a micro-strip antenna, a diversity antenna, or any other type of antenna suitable for sending and/or receiving wireless communication signals, blocks, frames, transmission streams, packets, messages and/or data. In some embodiments, antenna 133, antenna 134, antenna 143 and/or antenna 144 may be implemented as one or more separate units and/or combined units, e.g., a combination of transmit antenna(s), receive antenna(s), and/or transmit/receive antenna(s).

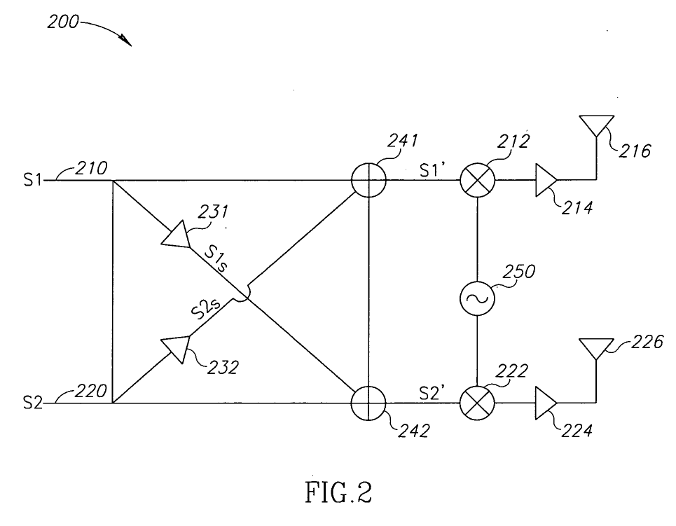

In accordance with some embodiments of the invention, multi-transmitter 130 may further include a crosstalk canceller (CC) 135 to reduce or cancel crosstalk between two or more transmitters of multi-transmitter 130, e.g., between transmitters 131 and 132. Crosstalk canceller 135 may include, for example, crosstalk canceller 200 of FIG. 2 or other one or more circuits or units as described herein.

In some embodiments, crosstalk canceller 135 and/or crosstalk canceller 145 may be implemented as one or more hardware components and/or software components, circuits, sub-circuits, analog-domain components, digital-domain components, or the like.

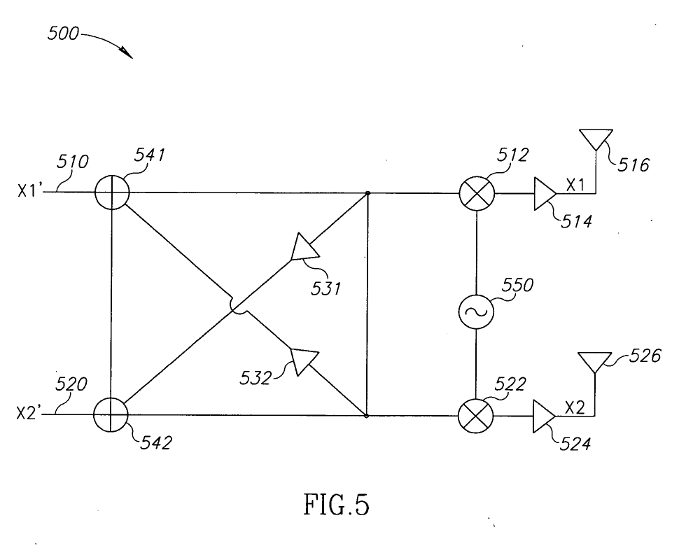

In accordance with some embodiments of the invention, multi-receiver 140 may further include a crosstalk canceller (CC) 145 to reduce or cancel crosstalk between two or more receivers of multi-receiver 140, e.g., between receivers 141 and 142. Crosstalk canceller 145 may include, for example, crosstalk canceller 500 of FIG. 5 or other one or more circuits or units as described herein.

Although crosstalk cancellers 135 and 145 are included in station 101, embodiments of the invention are not limited in this regard. For example, crosstalk canceller 135 and/or crosstalk canceller 145 may be included in other devices or components of system 100, e.g., in station 102, in an access point, in a base station, in a servicing station, or the like.

Although portions of the discussion herein may relate, for demonstrative purposes, to crosstalk cancellation of a MIMO configuration including two sub-units, namely, a multi-transmitter 130 and a multi-receiver, having two transmitters 131-132 and two receivers 143-144, respectively, embodiments of the invention are not limited in this regard, and may be used, for example, in conjunction with various other configurations or MIMO configurations, e.g., having more than two sub-units and/or having more than two transmitters or receivers per sub-unit.

FIG. 2 schematically illustrates a multi-transmitter crosstalk canceller 200 in accordance with an embodiment of the invention. In one embodiment, crosstalk canceller 200 may be an example of crosstalk canceller 135 of FIG. 1.

Crosstalk canceller 200 may include, for example, a first set of components, e.g., an upconverter 212, an amplifier 214 and an antenna 216, which may be implemented, for example, as a part of a first transmitter along a first transmission path 210; and a second set of components, e.g., an upconverter 222, an amplifier 224 and an antenna 226, which may be implemented, for example, as a part of a second transmitter along a second transmission path 220. Two signals, S1 and S2, may be intended for transmission along transmission paths 210 and 220, respectively. In some embodiments, signals S1 and S2 may be intended for transmission substantially simultaneously. In one embodiment, optionally, signal S1 may carry a first data stream, and signal S2 may carry a second, different, data stream. In one embodiment, signals S1 and S2 may be digital baseband signals, e.g., having an In-phase (I) component and a Quadrature (Q) components.

In accordance with some embodiments of the invention, a scaled component, e.g., scaled-up or scaled-down component, of signal S1 may be combined with signal S2, to result in a combined signal S2′ on transmission path 220. Additionally or alternatively, a scaled component, e.g., scaled-up or scaled-down component, of signal S2 may be combined with signal S1, to result in a combined signal S1′ on transmission path 210. According to this embodiment, instead of transmitting signals S1 and S2, transmission paths 210 and 220 may transmit the combined signals S1′ and S2′, respectively, thereby reducing or eliminating a possible crosstalk between transmission paths 210 and 220.

For example, a scaler 231, e.g., an attenuator or amplifier, may scale the signal S1 to result in a scaled signal S1ₛ; and a combiner 242, e.g., an adder or a subtracter, may combine the scaled signal S1ₛ with signal S2 along transmission path 220, resulting in a combined signal S2. Additionally or alternatively, a scaler 232 may scale the signal S2 to result in a scaled signal S2ₛ, and a combiner 241 may combine the scaled signal S2ₛ with signal S1 along transmission path 210, resulting in a combined signal S1′. In one embodiment, scaler 231 and/or scaler 232 may include digital multipliers, for example, complex digital multipliers which may be implemented, e.g., as part of processor 111 of FIG. 1. In one embodiment, scaler 231 and/or scaler 232 may include variable scalers, e.g., to allow improved cancellation of varying crosstalk and/or random crosstalk.

In transmission path 210, the combined signal S1′ may be upconverted using upconverter 212, e.g., a mixer, amplified using amplifier 214, and transmitted using antenna 216. Similarly, in transmission path 220, the combined signal S2′ may be upconverted using upconverter 222, e.g., a mixer, amplified using amplifier 224, and transmitted using antenna 226. In one embodiment, upconverters 212 and 222 may be connected to a clock 250, which may provide a carrier frequency for the transmission of combined signal S1′ and combined signal S2′.

In some embodiments, the scaling ratio, e.g., the upscaling or downscaling ratio used by scaler 231 and/or scaler 232 may be relatively high, for example, 10, 30, 50, 100, 200, or the like, for example, to achieve improved discrimination between the original signals, namely, S1 and S2, and the scaled signals, namely, S2ₛ and S1ₛ, respectively. A scaling ratio may be used for upscaling for example, a ratio of 30 may indicate upscaling e.g., by multiplying by 30; or may be used for downcaling, for example, a ratio of 30 may indicate downscaling by dividing by 30, or by multiplying by 1/30. In various implementations, the scaling ratio, as well as other properties of the components of crosstalk canceller 200, may be adapted to minimize or eliminate crosstalk.

In some embodiments, crosstalk between transmitter paths 210 and 220 may be smaller than approximately 0.1, for example, −20 dB, and scaling gain used by scalers 231 and/or 232 may be smaller than approximately 0.1. In one embodiment, for example, the crosstalk cancellation resolution may be smaller than 0.01 (e.g., −40 dB) or 0.001 (e.g., −60 dB).

In some embodiments, scalers 231 and 232 and combiners 241 and 242 may be placed at other suitable locations along transmission paths 210 and 220, for example, closer to antennas 216 and 226.

In some embodiments, optionally, coupling between transmission paths 210 and 220 may have a non-zero phase shift, such that signal coupling from transmission path 210 to transmission path 220 may be delayed relative to the original signal on transmission path 210. For example, scalers 231 and 232 may include complex-number multipliers to provide complex gain to signals S1 and S2, respectively, which may include In-phase (I) and Quadrature (Q) components and may be represented as complex numbers.

In some embodiments, scalers 231 and 232 may be implemented, for example, using a processor, e.g., processor 111 of FIG. 1, to perform mathematical operations on the 1 and Q components of signals S1 and S2. For example, signal S1 may be represented as I1+jQ1, and signal S2 may be represented as I2+jQ2, whereas j indicates imaginary components. The scaled signal S1ₛ may be generated by multiplying signal S1 by g1, the complex gain of scaler 231; and the scaled signal S2ₛ may be generated by multiplying signal S2 by g2, the complex gain of scaler 232. Then, the combined signal S1 may be generated by adding signal S1 and the scaled signal S2ₛ; and the combined signal S2′ may be generated by adding signal S2 and the scaled signal S1ₛ. In one embodiment, for example, the combined signals S1′ and S2′ may be represented using the following equations:
S1′=I1′+jQ1′=(I1+jQ1)+(I2+jQ2)*g2 Equation 1
S2′=I2′+jQ2′=(I2+jQ2)+(I1+jQ1)*g1 Equation 2

Other suitable equations and calculations may be used in accordance with embodiments of the invention.

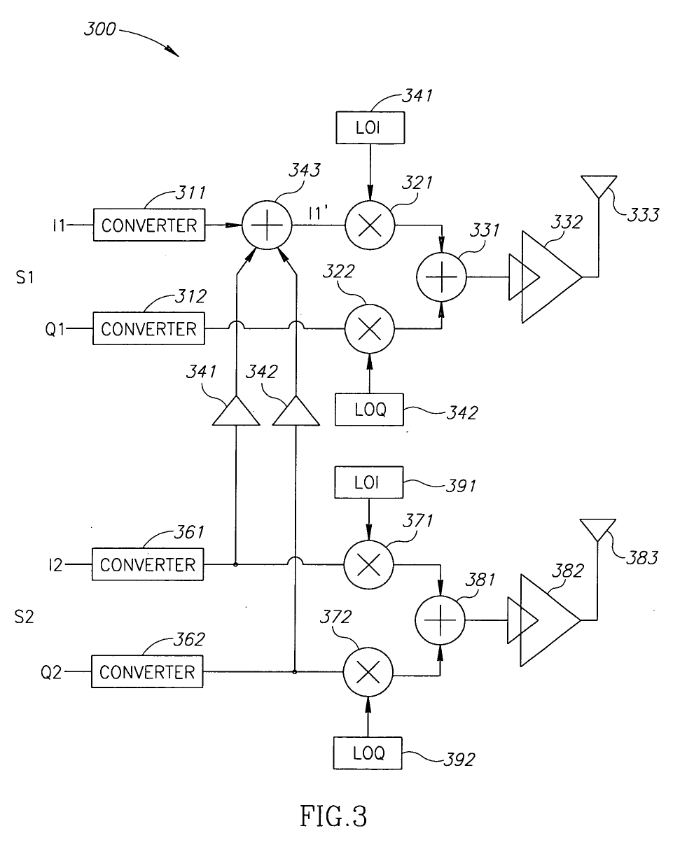

Reference is made to FIG. 3, which schematically illustrates a multi-transmitter crosstalk canceller 300 in accordance with an embodiment of the invention. In one embodiment, crosstalk canceller 300 may be an analog-domain implementation of Equation 1, and may reduce or eliminate possible crosstalk by separately handling the in-phase and quadrature components of multiple signals.

The in-phase component I1 and the quadrature component Q1 of signal S1 may be converted from digital to analog form, for example, using converters 311 and 312, respectively, which may include Digital to Analog Converters (DACs) and/or reconstruction filters. Similarly, the in-phase component I2 and the quadrature component Q2 of signal S2 may be converted from digital to analog form, for example, using converters 361 and 362, respectively. The analog components I2 and Q2 of signal S2 may pass through two scalers 341 and 342, respectively, which may include, e.g., amplifiers and/or attenuators. For example, scaler 341 may scale the real part of signal S2, and scaler 342 may scale the imaginary part of signal S2. The scaled components may be combined, using a combiner 343, with the in-phase component I1 of signal S1, resulting in a combined in-phase component I1′. Combiner 343 may include, for example, an adder or a subtracter. In one embodiment, scalers 341 and/or 342 may include transconductors whose output currents may be added to an output current of another transconductor in the I1 path, and the sum of the currents may drive a mixer, e.g., a Gilbert-type current steering mixer.

For purposes of clarity, crosstalk canceller 300 shows two scalers 341 and 342 to scale I2 and one combiner 343 to combine the scaled result with I1, thereby producing the combined signal I1′. For example, combiner 343 may receive multiple inputs, e.g., three inputs: scaled signal I2, scaled signal Q2, and signal I1; and combiner 343 may provide an output signal I1′. Similar sets of components may be included in crosstalk canceller 300, for example, to scale Q2 and add the scaled result to Q1, thereby producing the combined signal Q1′, to scale I1 and add the scaled result to I2, thereby producing the combined signal I2′, and to scale Q1 and add the scaled result to Q2, thereby producing the combined signal Q2′. For example, in some embodiments, the following equations may be used:
I1′=I1+I2s+Q2s Equation 3
Q1′=Q1+I2s+Q2s Equation 4
I2′=I2+I1s+Q1s Equation5
Q2′=Q2+I1s+Q1s Equation 6

The combined signal I1′ may be upconverted using an upconverter 321, for example, a mixer, e.g., driven by a Local Oscillator for In-phase component (LOI) 341. Similarly, the combined signal Q1′ may be upconverted using an upconverter 322, for example, a mixer, e.g., driven by a Local Oscillator for Quadrature component (LOQ) 342. The upconverted components may be added using an adder 331, amplified using a power amplifier 332, and transmitted using an antenna 333.

Similarly, the combined signal I2′ may be upconverted using an upconverter 371, for example, a mixer driven by a LOI 391; and the combined signal Q2′ may be upconverted using an upconverter 372, for example, a mixer driven by a LOQ 342. The upconverted components may be added using an adder 381, amplified using a power amplifier 382, and transmitted using an antenna 383.

In some embodiments, the operations of scalers 341 and 342 and combiner 343, as well as other sets of components used crosstalk canceller 300, may be represented using the following equations:
I1′+jQ1′=(I1+JQ1)+(I2+jQ2)*[Real(a232)+jImag(a232) Equation 7
I1′+jQ1′=[I1+I2*Real(a232) Q2*Imag(a232)]+j [Q1+I2*Imag(a232)+Q2*Real(a232)] Equation 8
wherein Real(a232) may represent the scaling by scaler 341, and wherein −Imag(a232) may represent the scaling by scaler 342. Other suitable equations may be used.

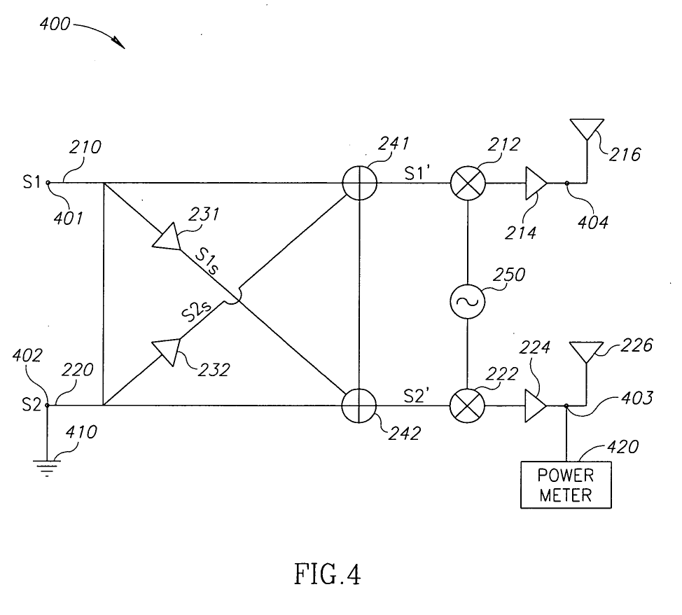

FIG. 4 schematically illustrates a calibrator 400 for calibrating a multi-transmitter crosstalk canceller in accordance with an embodiment of the invention. In one embodiment, calibrator 400 may be used to calibrate the crosstalk canceller 200 of FIG. 2.

Calibrator 400 may include the components of crosstalk canceller 200 of FIG. 2, and may further include a sink 410 and a power meter 420. A first signal S1 may be applied at a node 401 along transmission path 210. However, instead of applying a second signal S2 at a node 402 along transmission path 220, the sink 410 may be connected to node 402 to provide a zero signal at node 402. The sink 410 may include or may represent, for example, any suitable unit or component able to provide or apply a zero signal at node 402, and need not necessarily include a physical connection to the ground.

Signal S1 may be scaled using scaler 231, and the scaled signal S1ₛ may be added using combiner 242 into transmission path 220. Since a zero signal is applied to transmission path 220 by the sink 410, the power meter 420 connected at a node 403 is responsive to the sum of the scaled signal S1ₛ and the crosstalk introduced by transmission path 210. Therefore, power meter 420 indicates substantially zero power if the scaled signal S1ₛ cancels the crosstalk introduced by transmission path 210, e.g., when the scaled signal S1ₛ and the crosstalk are opposite. Accordingly, scaler 231 may be calibrated, adapted or configured, such that power meter 420 indicates substantially zero power, thereby indicating that the scaled signal S1ₛ cancels the crosstalk introduced by transmission path 210. In some embodiments, optionally, Local Oscillator (LO) leakage may be cancelled out, e.g., prior to or during the calibration process.

Similar calibration may be performed with regard to scaler 232 and transmission path 210, for example, by connecting a sink at a node 401, connecting a power meter at a node 404, and applying a signal S2 at a node 402.

In some embodiments, calibration or adjustment of scaler 231 and/or scaler 232 may utilize a pre-defined algorithm, for example, steepest descend algorithm. In some embodiments, the calibration process may be repeated periodically, for example, to compensate for possible drifts due to aging, temperature, environmental conditions, or the like. In one embodiment, a calibration process may be performed, for example, upon activation or turning on of a device in which calibrator 400 is included. In another embodiment, a calibration process may be performed when such device is idle, for example, at a time in which the device does not transmit data packets, or when the transmitted data of a particular transmitter is zero, e.g., during part of a preamble.

In some embodiments, power meter 420 may optionally be implemented, for example, by downconverting the RF signal (e.g., using one or more other circuit components or receiver components) and measuring a property, e.g., power or amplitude, of the signal at baseband. Other suitable implementations may be used.

In some embodiments, instead of using sink 410 to provide a zero signal, a pre-defined signal, e.g., a non-zero signal, may be provided, and the calibration process may be performed in relation to the applied pre-defined signal. In one embodiment, for example, orthogonal signals S1 and S2 may be applied at nodes 401 and 402, respectively, and a correlation technique may be used to isolate the scaled signals, S1ₛ and S2ₛ, from the applied signals S1 and S2.

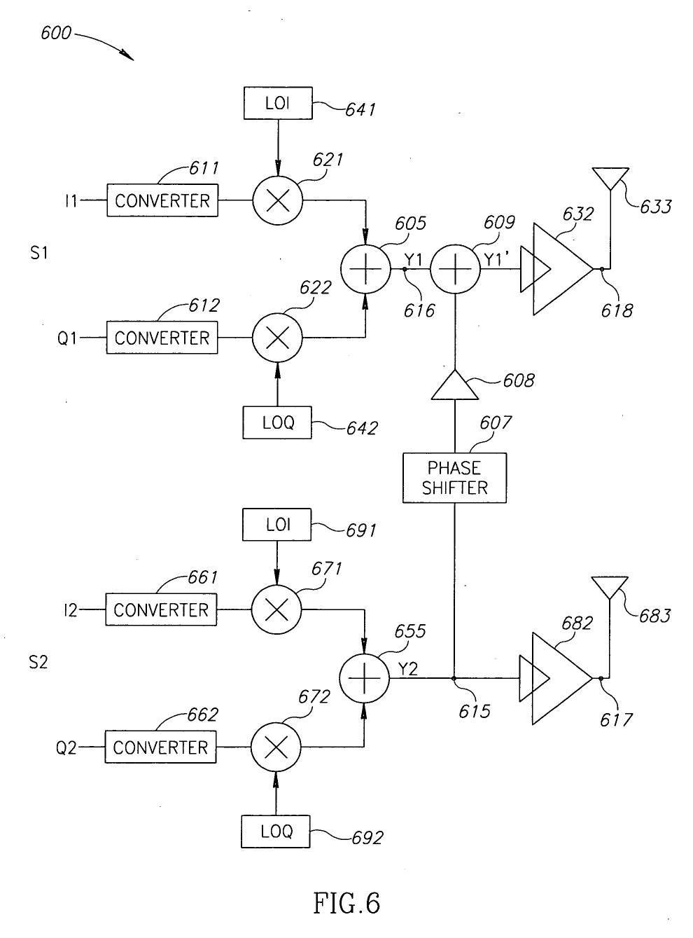

Although calibrator 400 shows a calibration mechanism having power meter 420 and sink 410 in the context of a multi-transmitter crosstalk canceller, embodiments of the invention are not limited in this regard. For example, similar calibration mechanisms and/or components may be used to calibrate other crosstalk cancellers in accordance with embodiments of the invention, for example, crosstalk canceller 300 of FIG. 3, crosstalk canceller 500 of FIG. 5, crosstalk canceller 600 of FIG. 6, or the like.

FIG. 5 schematically illustrates a multi-receiver crosstalk canceller 500 in accordance with an embodiment of the invention. In one embodiment, crosstalk canceller 500 may be an example of crosstalk canceller 145 of FIG. 1.

Crosstalk canceller 500 may include, for example, a first set of components, e.g., an antenna 516, an amplifier 514 and a downconverter 512, which may be implemented, for example, as a part of a first receiver along a first reception path 510; and a second set of components, e.g., an antenna 526, an amplifier 524 and a downconverter 522, which may be implemented, for example, as a part of a second receiver along a second reception path 520. Two signals, X1 and X2, may be intended for reception along reception paths 510 and 520, respectively. In some embodiments, signals X1 and X2 may be intended for reception substantially simultaneously. In one embodiment, optionally, signal X1 may carry a first data stream, and signal X2 may carry a second, different, data stream.

In accordance with some embodiments of the invention, a scaled component, e.g., scaled-up or scaled-down component, of signal X1 may be combined with signal X2, to result in a combined signal X2′ on reception path 520. Additionally or alternatively, a scaled component, e.g., scaled-up or scaled-down component, of signal X2 may be combined with signal X1, to result in a combined signal X1′ on reception path 510. Instead of carrying signals X1 and X2, reception paths 510 and 520 may carry the combined signals X1′ and X2′, respectively, thereby reducing or eliminating a possible crosstalk between reception paths 510 and 520.

In reception path 510, signal X1 may be received using antenna 516, amplified using amplifier 514, and downconverted using downconverter 512, e.g., a mixer. Similarly, in reception path 520, signal X2 may be received using antenna 526, amplified using amplifier 524, and downconverted using downconverter 522, e.g. a mixer. In one embodiment, downconverters 512 and 522 may be connected to a clock 550, which may provide a carrier frequency for the received signals X1 and X2.

A scaler 531, e.g., an amplifier and/or attenuator, may scale the signal X1 to result in a scaled signal X1ₛ; and a combiner 542, e.g., an adder or a subtracter, may combine the scaled signal X1ₛ with signal X2 along reception path 520, resulting in a combined signal X2′. Additionally or alternatively, a scaler 532 may scale the signal X2 to result in a scaled signal X2ₛ; and a combiner 541 may combine the scaled signal X2, with signal X1 along reception path 510, resulting in a combined signal S1′. Therefore, instead of carrying signals X1 and X2, reception paths 510 and 520 may carry the combined signals X1′ and X2′, respectively, thereby reducing or eliminating a possible crosstalk between reception paths 510 and 520. In one embodiment, scaler 531 and/or scaler 532 may include digital multipliers, for example, complex digital multipliers which may be implemented, e.g., as part of processor 111 of FIG. 1. In one embodiment, scaler 531 and/or scaler 532 may include variable scalers, e.g., to allow improved cancellation of varying crosstalk and/or random crosstalk.

Reference is made to FIG. 6, which schematically illustrates a multi-transmitter crosstalk canceller 600 in accordance with an embodiment of the invention. In one embodiment, crosstalk canceller 600 may be an analog-domain implementation of crosstalk canceller 135 of FIG. 1, and may reduce or eliminate possible crosstalk by handling combined in-phase and quadrature components of multiple signals.

The in-phase component I1 and the quadrature component Q1 of signal S1 may be converted from digital to analog form, for example, using converters 611 and 612, respectively, which may include DACs and reconstruction filters. Additionally or alternatively, the in-phase component I2 and the quadrature component Q2 of signal S2 may be converted from digital to analog form, for example, using converters 661 and 662, respectively.

Then, in-phase component I1 may be upconverted using an upconverter 621, e.g., a mixer driven by a LOI 641; and quadrature component Q1 may be upconverted using an upconverter 622, e.g., a mixer driven by a LOQ 642. Similarly, in-phase component I2 may be upconverted using an upconverter 671, e.g., a mixer driven by a LOI 691; and quadrature component Q1 may be upconverted using an upconverter 672, e.g., a mixer driven by a LOQ 692.

Upconverted components I1 and Q1 may be combined using a combiner 605 into a combined signal Y1. Similarly, components I2 and Q2 may be combined using a combiner 655 into a combined signal Y2. A phase shifter 607, e.g., a variable phase-shift generator or an all-pass network, may introduce into signal Y2 a phase shift or a phase delay, which may be represented as Angle1. The phase-shifted signal may be scaled using a variable scaler 608, and the scaled signal may be combined with signal Y1 using a combiner 609, to result in a combined signal Y1′. Signal Y1′ may be amplified using a power amplifier 632, and transmitted using an antenna 633.

In some embodiments, the operations of phase-shifter 607, scaler 608 and combiner 609 may be represented using the following equation:
Y1′=Y1+g*(Y2 delayed by Angle1) Equation 9
wherein g may represent the scaling ratio of scaler 608.

For purposes of clarity, crosstalk canceller 600 shows phase-shifter 607, scaler 608 and combiner 609 to produce the combined signal Y1′. A similar set of components may be included in crosstalk canceller 600, for example, to phase-shift signal Y1, to scale the phase-shifted signal, and to combine the scaled result to signal Y2, to result in a combines signal Y2′. Signal Y2′ may be amplified using a power amplifier 682, and transmitted using an antenna 683.

Although crosstalk canceller 600 includes phase-shifter 607, scaler 608 and combiner 609 connected between a node 615 and a node 616, embodiments of the invention are not limited in this regard. In some embodiments, phase-shifter 607, scaler 608 and combiner 609 may be connected, for example, between a node 617 and a node 618, at intermediate points of power amplifiers 632 and 682, or at other suitable locations subsequent to combining components I1 and Q1, and components I2 and Q2, into signals Y1 and Y2, respectively.

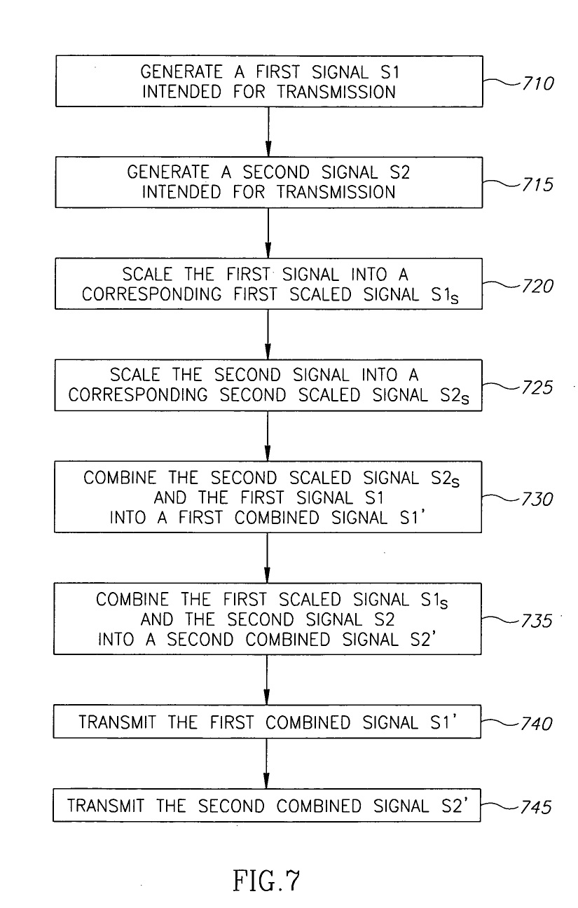

FIG. 7 is a schematic flow-chart of a method of crosstalk cancellation in accordance with an embodiment of the invention. Operations of the method may be implemented, for example, by one or more components, devices and/or circuits of FIGS. 1-6, and/or by other suitable stations, access points, circuits, controllers, modems, transceivers, processors, units, devices, and/or systems.

As indicated at box 710, the method may optionally include, for example, generating a first signal S1 intended for transmission, e.g., along a first transmission path.

As indicated at box 715, the method may optionally include, for example, generating a second signal S2 intended for transmission, e.g., along a second transmission path.

As indicated at box 720, the method may optionally include, for example, scaling the first signal into a corresponding scaled first signal S1ₛ.

As indicated at box 725, the method may optionally include, for example, scaling the second signal into a corresponding scaled second signal S2ₛ.

As indicated at box 730, the method may optionally include, for example, combining the scaled second signal S2ₛ and the first signal S1 into a combined first signal S1′, e.g., along the first transmission path.

As indicated at box 735, the method may optionally include, for example, combining the scaled first signal S1ₛ and the second signal S2 into a combined second signal S2′, e.g., along the second transmission path.

As indicated at box 740, the method may optionally include, for example, transmitting the combined first signal S1′, e.g., using a first antenna associated with the first transmission path.

As indicated at box 745, the method may optionally include, for example, transmitting the combined second signal S2′, e.g., using a second antenna associated with the second transmission path.

In some embodiments, some of the above operations may be performed in parallel or substantially simultaneously. For example, the operations of boxes 710 and 715 may be performed in parallel or substantially simultaneously; the operations of boxes 720 and 725 may be performed in parallel or substantially simultaneously; the operations of boxes 730 and 735 may be performed in parallel or substantially simultaneously; and/or the operations of boxes 740 and 745 may be performed in parallel or substantially simultaneously.

Although portions of the discussion herein may relate, for demonstrative purposes, to transmission paths, transmission chains, transmission lines, transmission operations, transmission circuits, transmission methods, transmission components, or the like, embodiments of the invention are not limited in this regard, and may be used in conjunction with reception paths, reception chains, reception lines, reception operations, reception circuits, reception methods, reception components, or the like.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Aspects, components and/or sub-circuits of one or more embodiments described herein may be combinable with aspects, components and/or sub-circuits of other one or more embodiments described herein.

Some embodiments of the invention may be implemented, for example, using a machine-readable medium or article which may store an instruction or a set of instructions that, if executed by a machine, for example, by system 100 of FIG. 1, by station 101 of FIG. 1, by station 102 of FIG. 1, by processor 111 of FIG. 1, by crosstalk canceller 200 of FIG. 2, by crosstalk canceller 300 of FIG. 3, by calibrator 400 of FIG. 4, by crosstalk canceller 500 of FIG. 5, by crosstalk canceller 600 of FIG. 6, or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit (e.g., memory unit 114 or storage unit 115), memory device, memory article, memory medium, storage device, storage article, storage medium and/or storage unit, for example, memory, removable or non-removable media, erasable or non-erasable media, writeable or re-writeable media, digital or analog media, bard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. An apparatus comprising:
a first transmission path to carry a first signal with information to be transmitted;
a second transmission path to carry a second signal with information to be transmitted;
a scaler associated with said first transmission path to scale said first signal into a scaled first signal; and
a combiner to combine said scaled first signal and said second signal into a combined second signal on said second transmission path.

2. The apparatus of claim 1, further comprising:
an antenna associated with said second transmission path to transmit said combined second signal.

3. The apparatus of claim 2, further comprising:
a second scaler associated with said second transmission path to scale said second signal into a scaled second signal; and
a second combiner to combine said scaled second signal and said first signal into a combined first signal on said first transmission path.

4. The apparatus of claim 3, further comprising:
a second antenna associated with said first transmission path to transmit said combined first signal.

5. The apparatus of claim 1, wherein said scaler is to scale said first signal by a ratio of at least 10.

6. The apparatus of claim 1, wherein said scaler is to scale said first signal by a ratio of at least 50.

7. The apparatus of claim 1, wherein said scaler comprises a complex multiplier to provide a complex gain to said first signal to result in said scaled first signal.

8. The apparatus of claim 1, wherein said scaler comprises:
a first analog scaler to scale an In-phase component of said first signal; and
a second analog scaler to scale a Quadrature component of said first signal.

9. The apparatus of claim 1, further comprising:
a phase shifter to modify a phase of said first signal before said first signal enters said scaler.

10. The apparatus of claim 1, wherein said second signal is a pre-defined signal, and further comprising a power meter to measure said combined second signal to calibrate said scaler.

11. A wireless communication device comprising:
an apparatus according to claim 1; and
an antenna associated with said second transmission path to transmit said combined second signal.

12. The apparatus of claim 4, further comprising:
a first reception path to carry a third signal with information to be received;
a second reception path to carry a fourth signal with information to be received;
a third scaler associated with said first reception path to scale said third signal into a scaled third signal; and
a third combiner to combine said scaled third signal and said fourth signal into a combined fourth signal on said second reception path.

13. The apparatus of claim 12, further comprising:
a fourth scaler associated with said second reception path to scale said fourth signal into a scaled fourth signal; and
a fourth combiner to combine said scaled fourth signal and said third signal into a combined third signal on said first reception path.

14. The apparatus of claim 12, wherein said third scaler is to scale said third signal by a ratio of at least 30.

15. The apparatus of claim 12, wherein said third scaler comprises a complex multiplier to provide a complex gain to said third signal to result in said scaled third signal.

16. The apparatus of claim 12, wherein said third scaler comprises:
a first analog scaler to scale an In-phase component of said third signal; and
a second analog scaler to scale a Quadrature component of said third signal.

17. The apparatus of claim 12, further comprising:
a phase shifter to modify a phase of said third signal before said third signal enters said third scaler.

18. The apparatus of claim 12, wherein said fourth signal is a pre-defined signal, and further comprising a power meter to measure said combined fourth signal to calibrate said third scaler.

19. A wireless communication system comprising:
a wireless communication station comprising:
a first transmission path to carry a first signal with information to be transmitted;
a second transmission path to carry a second signal with information to be transmitted;
a scaler associated with said first transmission path to scale said first signal into a scaled first signal; and
a combiner to combine said scaled first signal and said second signal into a combined second signal on said second transmission path.

20. The wireless communication system of claim 19, comprising another wireless communication station to receive said combined second signal.

21. The wireless communication system of claim 19, comprising a wireless servicing station to receive said combined second signal.

22. The wireless communication system of claim 19, comprising a wireless access point to receive said combined second signal.

23. A method comprising:
carrying on a first transmission path a first signal with information to be transmitted;
carrying on a second transmission path a second signal with information to be transmitted;
scaling said first signal into a scaled first signal; and
combining said scaled first signal and said second signal into a combined second signal on said second transmission path.

24. The method of claim 23, further comprising:
transmitting said combined second signal.

25. The method of claim 24, further comprising:
scaling said second signal into a scaled second signal; and
combining said scaled second signal and said first signal into a combined first signal on said first transmission path.

26. The method of claim 25, further comprising:
transmitting said combined first signal.

27. The method of claim 26, further comprising:
carrying on a first reception path a third signal with information to be received;
carrying on a second reception path a fourth signal with information to be received;
scaling said third signal into a scaled third signal; and
combining said scaled third signal and said fourth signal into a combined fourth signal on said second reception path.

28. The method of claim 27, further comprising:
scaling said fourth signal into a scaled fourth signal; and
combining said scaled fourth signal and said third signal into a combined third signal on said first reception path.
